(19) United States
(12) Patent Application Publication
(10) Pub. No.: US 2012/0330557 A1
(43) Pub. Date: Dec. 27, 2012

(54) System for Cardiac Condition Analysis Based on Cardiac Operation Patterns

(75) Inventors: Hongxuan Zhang, Palatine, IL (US); Steve D. Quam, Carpentersville, IL (US)

(73) Assignee: SIEMENS MEDICAL SOLUTIONS USA, INC., Malvern, PA (US)

(21) Appl. No.: 13/401,989

(22) Filed: Feb. 22, 2012

Related U.S. Application Data
(60) Provisional application No. 61/499,788, filed on Jun. 22, 2011.

(51) Int. Cl. G06F 19/00

(52) U.S. Cl. 702/19

(57) ABSTRACT

A system for heart performance monitoring stores image data representing a sequence of medical images of a surface of a patient heart acquired over multiple contraction and reperfusion cycles. An image data processor automatically processes the image data to determine, change in displacement of selected points of a region of interest of the heart surface over individual cycles of the multiple contraction and reperfusion cycles, maximum and minimum peak displacement points and associated relative times of occurrence of the maximum and minimum peak displacement points and individual parameters related to change in displacement of corresponding individual points of the selected points. A display image shows a grid of individual parameters and an individual grid cell employs a visual attribute to visually indicate degree of change in an associated individual parameter occurring over the multiple contraction and reperfusion cycles.

This is a non-provisional application of provisional application Ser. No. 61/499,788 filed Jun. 22, 2011, by H. Zhang et al.

### FIELD OF THE INVENTION

This invention concerns a system for heart performance monitoring and abnormality detection in response to degree of change in displacement of individual points of a region of interest of a heart surface occurring over contraction and reperfusion cycles.

### BACKGROUND OF THE INVENTION

Myocardial ischemia and infarction analysis and detection within ventricular tissue, for example, is used in the management of cardiac disorders and irregularities, which are caused by a lack of blood and oxygen, in heart tissue. Usually, surface ECG signal analysis based on waveform morphology and time domain parameters, is utilized for myocardial ischemia and infarction detection and characterization, such as by determination of ST segment or T wave changes (associated with repolarization). However known systems fail to provide a comprehensive quantitative method for myocardial status detection and characterization, such as for severity characterization of an ongoing myocardial ischemia event with chest pain and discomfort. Additionally, known systems for cardiac ischemia and infarction identification and analysis based on ECG signals are typically subjective and need extensive expertise for accurate pathology interpretation and proper cardiac rhythm management.

Coronary Artery Disease (CAD) and heart-related problems and cardiac arrhythmias are severe frequently fatal conditions. A 12-lead electrocardiogram (ECG) and multi-channel intra-cardiac electrogram (ICEG) comprise a diagnostic reference standard used for evaluating cardiac rhythm and events. Known waveform morphology and time domain parameter analysis, such as of a P wave, QRS complex, ST segment and T wave, are used for cardiac arrhythmia monitoring and identification, e.g. of atrial fibrillation (AF), myocardial ischemia (MI) and ventricular tachycardia/fibrillation (VT/VF), for example. However, waveform morphology and time domain parameter analysis are sometimes subjective and time-consuming, and require extensive expertise and clinical experience for accurate interpretation and proper cardiac rhythm management.

Cardiac electrophysiological activities and signals (ECG and ICEG signals) are time varying and known signal analysis typically fails to localize a precise malfunction and identify its severity and an associated trend of cardiac events (e.g. of myocardial ischemia and infarction), such as cardiac pathology irregularity stages and arrhythmia occurrence. Known clinical diagnosis of myocardial ischemia and infarction detection and characterization are based on ST segment voltage deviation for ischemia event detection (e.g. 0.1 mV elevation is a clinical standard for myocardial ischemia (MI) detection). However this standard only works for surface ECG signals, not for intra-cardiac electrograms (ICEG signals) and ST segment (voltage) deviation fails to indicate myocardial ischemia severity.

Known systems for myocardial ischemia and infarction analysis typically need a benign signal as a baseline for threshold determination of events and lack reliability, stability and accuracy, especially in emergency cases. Known methods for MI analysis focus on an event in a qualitative manner involving detection and evaluation of MI occurrence. These methods lack a capability for quantitative characterization of MI severity. Furthermore, known ischemia event detection systems may cause a false alarm due to reliance on single parameter analysis such as measurement of magnitude of an ST segment. Known medical applications also need improved accuracy and capability for timely detection and characterization of an MI event, which can be used in an ICD (Implantable Cardiac Defibrillator) or a portable system in cardiac applications, such as Holster monitoring.

During a heart operation, fast continuous image scanning and acquisition using X-ray and ultrasound imaging devices, for example provide accurate cardiac tissue and vessel and chamber movement information including heart contraction and reperfusion information. Known systems typically involve real time catheter position tracking, blood flow visualization using a contrast agent and cardiac tissue (such as muscle, valve) position and movement localization using image edge detection of different functional tissues and chambers. In known fluoroscopic and ultrasound imaging, continuous sampled image pictures of the heart and cardiac tissue are not fully utilized for continuous cardiac function evaluation. Known clinical methods for cardiac chamber and heart tissue diagnosis, involve a need for extensive clinical experience and knowledge for accurate interpretation of parameters including of dynamic movement patterns and trends and determination of severity of pathology, type of potential arrhythmia and location of a malfunction.

Known systems for cardiac image interpretation focus on qualitative diagnosis, capture of blood flow and direction and lack both qualitative and quantitative methods. These systems fail to use calculations characterizing chamber dynamic contraction patterns, blood vessel perfusion variation, and location and severity of potential arrhythmia, such as of an atrial fibrillation site in right and left atrial chambers. Known cardiac imaging methods in an operating room focus on catheter insertion, stent installation and blood flow monitoring and lack quantitative characterization capability. Known systems use surface ECG signals (R wave) and respiration signals to gate image acquisition to avoid patient movement noise and artifacts but involve increased image noise and blurring and potentially fail to acquire images at diagnostically valuable times within a heart cycle. A system according to invention principles addresses these deficiencies and related problems.

### SUMMARY OF THE INVENTION

A system uses non-invasive continuous image scanning of heart chamber contraction and reperfusion to qualitatively and quantitatively analyze blood flow and related hemodynamic functions by determining hemodynamic activity patterns. A system for heart performance monitoring and abnormality detection includes a repository, image data processor and display processor. The repository stores image data representing a sequence of medical images of a surface of a patient heart acquired over multiple contraction and reperfusion cycles. The image data processor automatically processes the image data to determine, change in displacement of selected points of a region of interest of the heart surface over individual cycles of the multiple contraction and reperfusion cycles, maximum and minimum peak displacement points and associated relative times of occurrence of the maximum and minimum peak displacement points and individual parameters related to change in displacement of corresponding individual points of the selected points. The display processor initiates generation of data representing a display image showing a grid of multiple cells individually representing the individual parameters and an individual cell employs a visual attribute to visually indicate degree of change in an associated individual parameter occurring over the multiple contraction and reperfusion cycles.

### BRIEF DESCRIPTION OF THE DRAWING

FIG. 1 shows a system for heart performance characterization and abnormality detection, according to invention principles.

FIG. 2 shows continuous image scanning and acquisition of an anatomical area and calculation of a contraction pattern parameter for a selected heart portion, according to invention principles.

FIG. 3 shows an example of atrial chamber 2D contraction and reperfusion and associated pattern analysis and characterization, according to invention principles.

FIG. 4 shows automatic image point selection and associated signal extraction, according to invention principles.

FIG. 5 shows a Table including parameters of a cardiac region of interest (ROI) waveform used for cardiac mode and pattern analysis, according to invention principles.

FIG. 6 shows a flowchart of a process used by the system for cardiac function pathology diagnosis and characterization, according to invention principles.

FIG. 7 shows atrial fibrillation and activity analysis based on heart activity waveform pattern analysis, according to invention principles.

FIG. 8 shows a flowchart of a process used by a system for heart performance characterization and abnormality detection, according to invention principles.

### DETAILED DESCRIPTION OF THE INVENTION

A system uses non-invasive continuous image scanning of chamber contraction and reperfusion to analyze blood flow and related hemodynamic functions qualitatively and quantitatively. A heart function parameter, contraction and reperfusion timing, and hemodynamic activity patterns, are determined in analyzing heart function and tissue characteristics, especially for atrial fibrillation and myocardial ischemia detection. In addition, statistical analysis of a chamber contraction pattern and tissue function is used to provide an improved diagnosis with better sensitivity and stability, especially in noisy conditions. The system supports identifying cardiac disorders, differentiating between types of cardiac arrhythmias, characterizing pathological severity, predicting life-threatening events, and evaluating effect of drug administration.

The system uses contraction and reperfusion volume and time interval patterns for cardiac arrhythmia monitoring and diagnosis, especially for detection of myocardial ischemia and blood vessel blockage. Usually electrophysiological activities (such as surface ECG and intra-cardiac electrograms) and images with contrast agent are used to detect heart arrhythmia and pathology. However hemodynamic signals, such as blood flow volume in a cardiac chamber, may provide earlier detection information since electrophysiological signal changes are typically the consequence of change in hemodynamic characteristics and may be utilized for cardiac event diagnosis and tissue function signatures.

The system provides continuous cardiac function evaluation of chamber movement patterns and cardiac chamber and tissue movement. The movement is associated with time stamps over multiple heart cycles. The system provides gated image scanning, such as P wave gated atrial chamber scanning and QRS complex wave gated left ventricular function pattern analysis. Further, the system gates image acquisition by function, ROI (region of interest) location and time within a heart cycle to reduce X-ray radiation dose administered. Thereby the system provides cardiac chamber contraction function analysis, blood vessel reperfusion diagnosis, heart muscle movement pattern characterization and hemodynamic function variation identification. The system identifies distortion and variation of chamber size, edges, volumes and latency, using image acquisition trigger patterns for detailed cardiac function diagnosis. The system analyzes 2D (two dimensional) and 3D (three dimension) image data acquired with different timing patterns. The image acquisition is triggered in one embodiment using a P wave gated right atrial chamber 2D boundary edge representative signal used for contraction speed determination and latency determination in different directions of a right chamber.

The system determines signal pattern data, using continuous image scanning to provide a) a Chamber edge representative signal waveform, b) a Chamber contraction size to time ratio representative signal waveform, c) a Heart excitation pathway and timing representative signal waveform and d) a chamber (or cardiac muscle) excitation energy flow and dissipation representative signal waveform. Furthermore, the representative signal waveforms may be derived by synchronizing with ECG signals, blood pressure signals, SPO2 signals and respiration signals. The system analyzes the representative signal waveforms for cardiac function diagnosis and characterization and atrial fibrillation site detection and localization as well as severity and treatment priority diagnosis.

Different clinical applications and procedures may need different kinds of data for detection of cardiac arrhythmia. For example, in atrial fibrillation analysis, usually a fixed chamber model and multi-channel intra-cardiac electrophysiological signals are utilized to detect atrial tissue and muscle EP response. However heart chamber, myocardial tissue and muscles are not rigid, which means soft cardiac tissue and myocardium are continuously moving, squeezing, contracting and reperfusing based on cardiac excitation and pacing. The system extracts and characterizes non-rigid dynamic changes of a ROI in the inner wall myocardium of the heart chamber and determines a ROI wall movement pattern of a cardiac chamber (such as an ischemic portion exhibiting abnormal contraction in a left ventricle). The system also determines a chamber contraction dynamic ratio and heart tissue dynamic operation pattern (including size, volume, blood flow, energy accumulation).

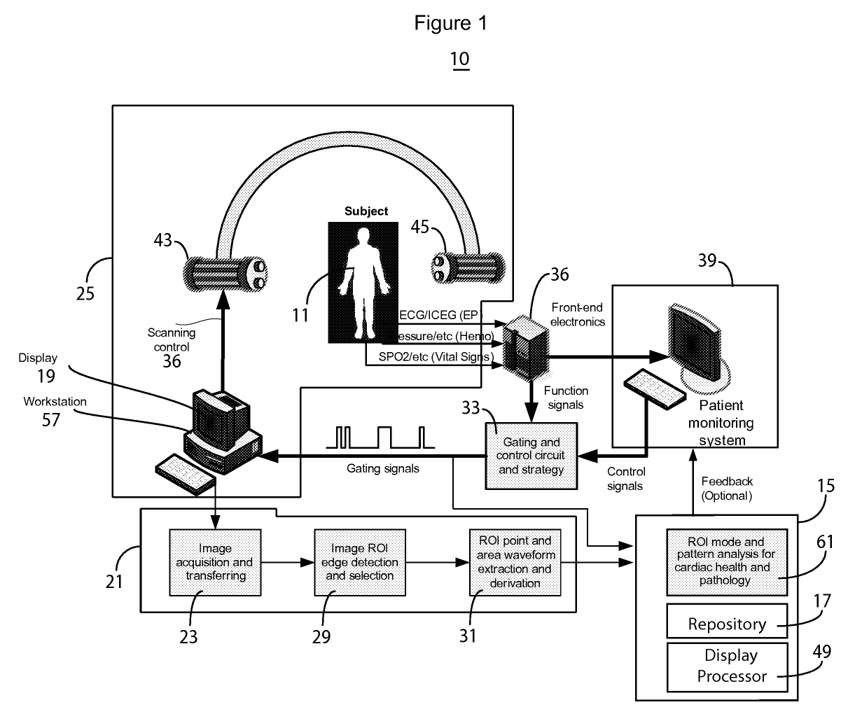

FIG. 1 shows system 10 for heart performance characterization and abnormality detection using patient real time monitoring signal gated image scanning. System 10 integrates image scanning system 25 and patient signal monitoring system 39. Imaging system 25 comprises radiation source 43 and detector 45 residing on a C-arm rotatable about patient 11 under control of a user via workstation 57 that also displays acquired images via display 19. Workstation 57 includes a user interface (e.g. keyboard, mouse, touchscreen, voice recognition device) for user data and command entry into system 10 via a graphical user interface (GUI) presented on display 19. Patient monitoring signals including ECG, ICEG, blood pressure, SPO2 and other vital sign signals, are acquired from patient 11 buffered, filtered, amplified and digitized by interface 36 and processed for display by patient monitoring system 39. The acquired patient monitoring signals are processed by synchronization processor 33 to generate an image acquisition trigger signal used by imaging system 25 to acquire images of patient 11. System 10 uses a synchronization signal from processor 33 to image heart and chamber cardiac function and minimize acquisition of redundant images which reduces acquisition and signal processing time, use of system energy and radiation exposure. Processor 33 provides a cardiac function synchronization signal derived from ECG, blood pressure acceleration signals, EP frequency signals, calculated power and spectrum signals, for example. The trigger signals from processor 33 may be uniform and non-uniform, depending data indicating a clinical application or procedure.

System 10 comprises at least one computer system, workstation, server or other processing device comprising image data processor 21 for analyzing acquired images and signal processor 15 including pattern analyzer 61 for cardiac condition determination, display processor 49 and repository of data 17. Repository of data 17 comprises a repository of image data representing a sequence of medical images of a surface of a patient heart acquired by system 25 over multiple contraction and reperfusion cycles. Repository 17 also stores determined parameters, selectable predetermined functions, ECG signal data and derived output parameters. Image data processor 21 includes image acquisition interface 23, anatomical region of interest edge detection and selection unit 29 and image point selection and associated parameter determination unit 31. Image data processor 21 automatically processes acquired image data to determine, change in displacement of selected points of a region of interest of the heart surface over individual cycles of the multiple contraction and reperfusion cycles, maximum and minimum peak displacement points and associated relative times of occurrence of the maximum and minimum peak displacement points and individual parameters related to change in displacement of corresponding individual points of the selected points. Display processor 49 in signal processor 15 initiates generation of data representing a display image showing a grid of a plurality of cells individually representing the individual parameters and an individual cell employs a visual attribute to visually indicate degree of change in an associated individual parameter occurring over the multiple contraction and reperfusion cycles.

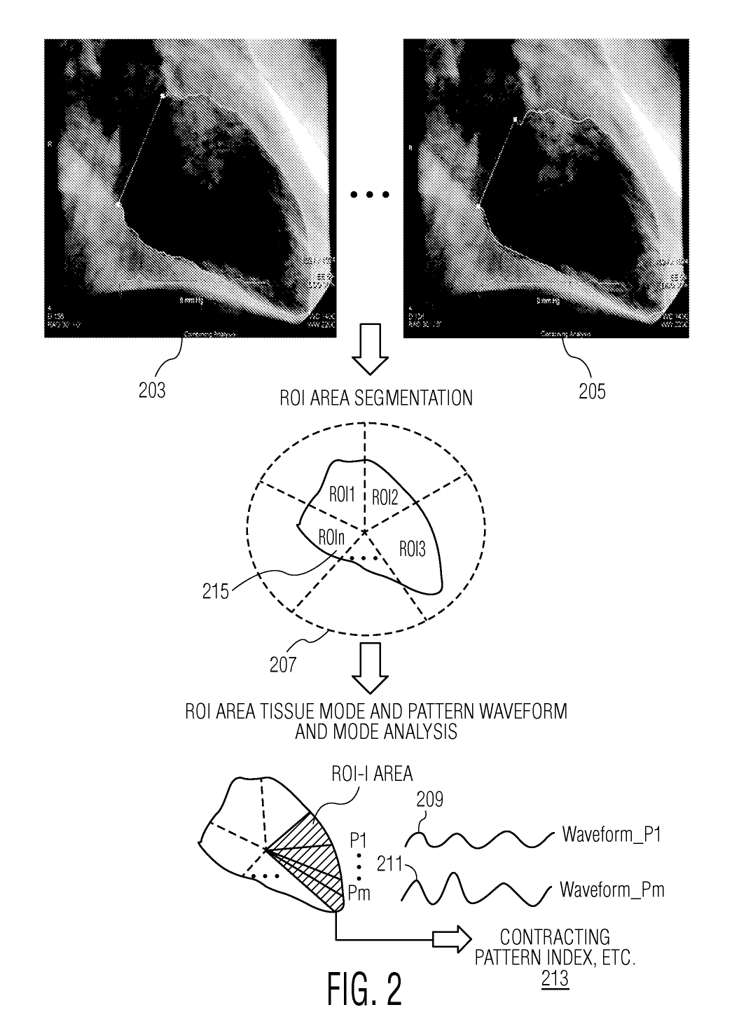

FIG. 2 shows continuous image scanning acquisition of an anatomical area and calculation of a contraction pattern parameter for a selected heart portion. System 10 selects and monitors a ROI of a ventricular wall of ventricle chamber images 203, 205 during contraction and reperfusion procedures and analyzes associated signal patterns. In operation, an automatic chamber edge selection and tracking function detects, and characterizes abnormal areas in the cardiac tissue. The system detects areas within a heart chamber, such as an atrial chamber exhibiting fibrillation or an associated trend. Furthermore, the system performs area segmentation in 2D or 3D as illustrated in segmented ventricle 207. Signal processor 15 calculates a contraction pattern parameter 213 for a selected heart portion. In continuous image scanning using an X-ray system 25 (or an ultrasound image scanning system) increasing scanning speed improves quality of derived displacement signals for a ROI. Image data processor 21 selects a ROI, performs edge detection and marking to select the ROI area (such as a left ventricle chamber). The edge of a ROI is automatically and adaptively marked and located during heart contraction and movement (such as ROIn 215). In response to ROI segmentation and selection (such as ROI1, ROI2, ROI3), the system tracks the selected ROI area by generating displacement waveform for anatomical points (such as P1 209, Pm 211). The system monitors points P1 209, Pm 211 and ROI area movement and contraction and derives corresponding signal waveforms representing movement of the selected marked ROI area, such as waveform_Pm 211 of selected point Pm. The system calculates parameters for diagnosing and characterizing the pattern of the ROI area and analyzes the waveform to detect, locate and quantify abnormality of the tissue and cardiac function and identify abnormality type, severity, treatment energy and treatment area priority.

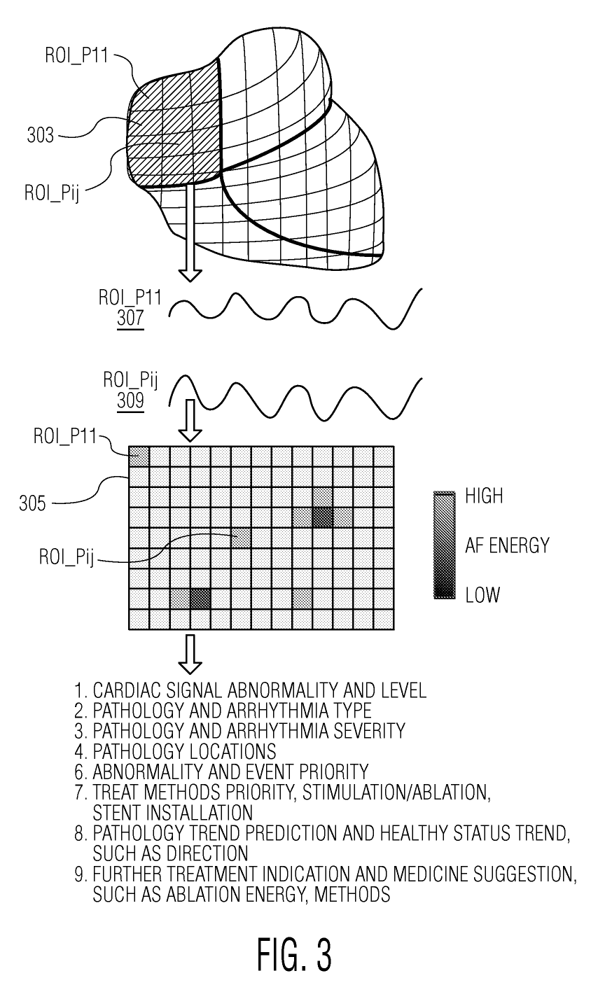

FIG. 3 shows an example of atrial chamber 2D contraction and reperfusion and associated pattern analysis and characterization. Displacement of selected points (e.g. P11 307, Pij 309) of a single chamber function area 303 are mapped in 2D over individual cycles of contraction and reperfusion cycles to a cell grid 305 identifying maximum and minimum peak displacement point locations and associated relative times of occurrence of the maximum and minimum peak displacement points. The system also calculates individual parameters related to change in displacement of corresponding individual points of the selected points. The cell grid heart point displacement mapping 305 is used for diagnosis of arrhythmia or other abnormality. The signal chamber area 303 is an atrial chamber and the atrial chamber image is segmented into different cells (P11-Pij) based on required diagnosis sensitivity. System 10 determines movement and contraction position and associated continuous waveform displacements of cell points from a zero reference point comprising a position of tissue at rest with no cardiac contraction and reperfusion.

A displacement waveform is derived from continuous image scanning and acquisition comprising cell waveforms e.g. P11 307, Pij 309. Image data processor 21 generates a 2D mapping of segmented atrial cell displacement and associated derived displacement related parameters of area 303 to corresponding cell parameter grid 305. The color (or another visual attribute) of grid 305 shows the severity and type of abnormality such as atrial fibrillation, for example and the position and location of each cell of grid 305 correspond accurately to a tissue location of atrial chamber 303. A physician is able to view a characterization of individual cell locations of atrial chamber 303, and determine treatment, such as ablation position priority, ablation energy and ablation frequency. The pattern analysis presented in grid 305 characterizes tissue quantitatively and qualitatively and identifies abnormal point location, abnormality severity, type and treatment priority. System 10 analyzes continuously acquired images to characterize individual cell locations of atrial chamber 303.

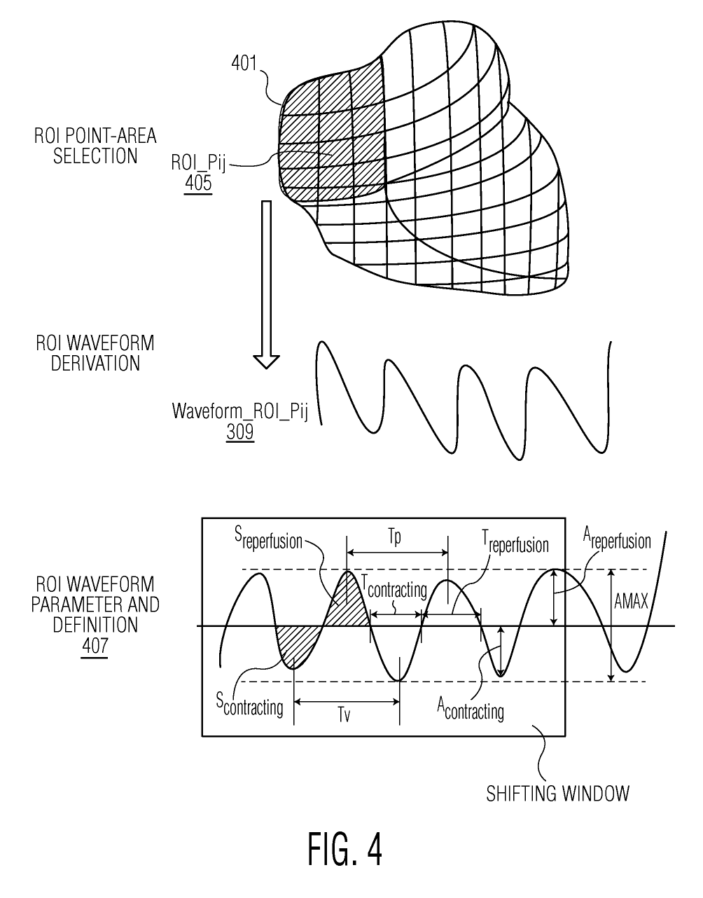

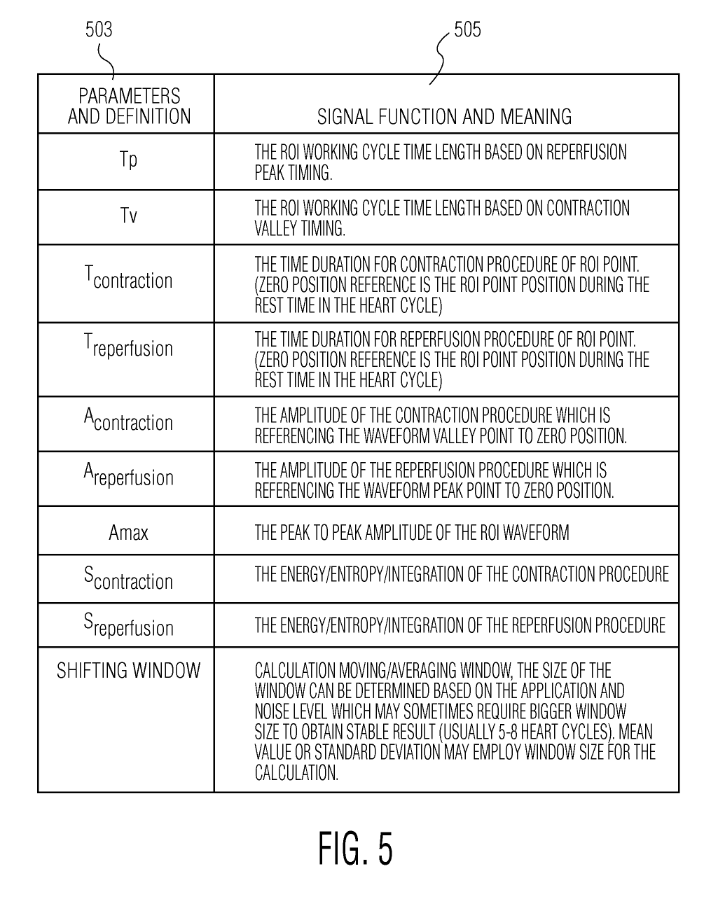

FIG. 4 shows automatic image point selection and associated signal extraction. Image data processor 21 and signal processor 15 perform different kinds of calculation and waveform parameter determination to analyze a cardiac ROI. A ROI point derived waveform 403 from image ROI cell area 405 is acquired from a continuous sequence of X-ray scanning images using automatic edge and point position extraction, localization and displacement determination occurring over multiple heart cycles. System 10 determines a waveform indicating contraction and reperfusion, for each ROI point or cell in atrial chamber 401. Image data processor 21 and signal processor 15 for individual waveforms derived from cell points assigned in atrial area 401, determine parameters Tp, Tv, T_{contraction} T_{reperfusion} A_{reperfusion} A_{contraction}Amax, S_{contraction} and S_{reperfusion} as shown in waveform 407 and defined in the Table of FIG. 5.

FIG. 5 shows a Table identifying parameters in column 503 of a cardiac region of interest (ROI) waveform used for cardiac mode and pattern analysis and a corresponding parameter description in column 505. The parameters include Tp indicating a cycle time length based on reperfusion peak timing, Tv indicating a cycle time length based on contraction valley timing, T_{contraction} indicating a time duration for a contraction procedure, T_{reperfusion} indicating a time duration for a reperfusion procedure. Further, A_{contraction} indicates amplitude of a contraction procedure, A_{reperfusion} indicates amplitude of a reperfusion procedure, Amax indicates peak to peak amplitude of a ROI displacement waveform, S_{contraction} indicates an energy or entropy integral value of a contraction procedure and S_{reperfusion} indicates an energy or entropy integral value of a reperfusion procedure. Further, the system uses a shifting window having a size (e.g. a number of heart cycles) adaptively determined by signal processor 15 in response to data indicating a clinical application or procedure and image data noise level. The system increases window size (usually within 5-8 heart cycles) in response to increasing noise level and also uses a determined window size in calculating a mean value or standard deviation value.

An individual parameter may be used independently for cardiac condition analysis. Different parameters are also used in combination to obtain an index value for diagnosing and characterizing individual points associated with assigned cells of cardiac area. In addition, parameter values averaged over multiple heart cycles are used for diagnosis of points associated with assigned cells of cardiac area, especially in a noisy environment, such as during ablation and electrical shock applications. Image data processor 21 and signal processor 15 automatically calculate parameters including the following.

Single point Pi amplitude contraction-reperfusion variation=

$$mean ( {A}_{waveform \_ Pi} ) / var ( {A}_{waveform \_ Pi} )$$

Single point Pi contraction-reperfusing timing ratio=

$$\frac{mean ( {T}_{contracting} ( waveform\_Pi ) )}{mean ( {T}_{reperfusion} ( waveform\_Pi ) )} or = \frac{mean ( {T}_{V} ( waveform\_Pi ) )}{mean ( {T}_{P} ( waveform\_Pi ) )} .$$

Single point Pi contraction-reperfusing energy ratio=

$$\frac{mean ( {S}_{contracting} ( waveform\_Pi ) )}{mean ( {S}_{reperfusion} ( waveform\_Pi ) )}$$

where, A_{waveform}_{_{—}}ₚᵢ represents A_{contraction}, A_{reperfusion}, Amax and the mean value and standard deviation (Var) are calculated using a shifting window as previously described. An area of a ROI area comprises multiple points where displacement waveforms are acquired. The system employs a pattern parameter function comprising,

$$area contraction \text{-} reperfusion ratio = {\sum }_{i ∈ ROI \_ area} {α}_{i} \cdot {Ratio}_{{ROI \_ P}_{i}}$$

where Ratio_{ROI}_{_{—}}_{P}_{ᵢ} is a contraction and perfusion ratio of a single point on an anatomical area and αᵢ is an integration coefficient. A user or the system selects a ROI for determination of an anatomical area pattern and omits data from a noisy or unwanted ROI point from a calculated equation. Further, a, may be time varying and the system may determine and adaptively modify calculation parameters in real time.

The system also employs a heart chamber pattern parameter function comprising,

$$chamber contraction \text{-} reperfusion ratio = {\sum }_{i ∈ ROI \_ Chamber} {α}_{i} \cdot {Ratio}_{{ROI \_ P}_{i}}$$

where the area analyzed is a chamber of a heart, or another interesting area portion. Ratio_{ROI}_{_{—}}ₚ_{ᵢ}, is a contraction and perfusion ratio of a single ROI point and αᵢ is an integration coefficient. Usually a user or the system selects a ROI and αᵢ may be constant or time varying.

Signal processor 15 also performs a frequency analysis, spectral analysis, energy analysis, wavelet analysis, complexity analysis and entropy analysis. Image system 25 is synchronized with patient monitoring system signals, such as an ECG signal, ICEG signal or vital sign signal. System10 detects cardiac function abnormality earlier by analyzing synchronization timing and latency. For example, the latency delay timing between an R wave (ECG signal) and peak time of heart contraction or reperfusion in a derived waveform is used for cardiac pathology diagnosis. Furthermore, the system in one embodiment determines displacement related parameters with dis-continuous image scanning. For example, dis-continuous image scanning occurs when using an intra-cardiac ultrasound system that requires a cooling period following continuous heart scanning for a 5-10 minute period. Similarly, an X-ray imaging system employs dis-continuous image scanning in order to reduce radiation dose. System 10 calculates displacement parameters as long as multiple cardiac cycles of image data are available and sufficient to derive a displacement waveform.

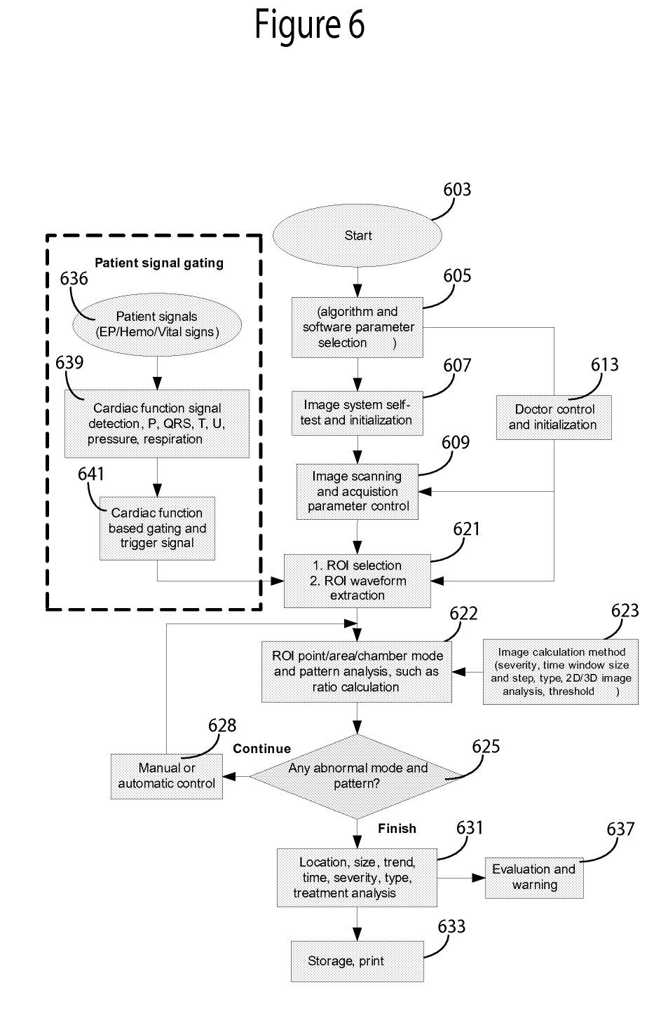

FIG. 6 shows a flowchart of a process used by system 10 (FIG. 1) for cardiac function pathology diagnosis and characterization based on derived displacement waveforms of points of a cardiac area. The displacement waveforms are analyzed to characterize contraction and reperfusion procedures. The waveforms are derived from acquired patient images using image object edge detection functions involving identifying image boundaries based on transition in pixel luminance The image scanning and acquisition parameters used by system 25 are adaptively selected by the system in deriving a displacement waveform in response to a synchronization signal. The system also determines detection thresholds used for identifying severity and type of a medical condition.

System 10 in step 605 selects displacement waveform parameters to determine and calculate and threshold values following the start at step 603 and in step 607 performs a system self test and system initialization. Image acquisition and scanning parameters are selected and a sequence of images is acquired in step 609 and a cardiac region of interest to be analyzed and associated displacement waveform points are selected and displacement waveforms extracted in step 621. The image scanning and acquisition is gated and synchronized using a trigger signal derived by synchronization processor 33 from ECG and other patient signals acquired from patient 11 by interface 36 and patient monitoring system 39. Selection of parameters in steps 605, 609 and 621 is automatically performed by the system or alternatively in response to user command in step 613 at different times in the process. Synchronization processor 33 derives the trigger signal using input signals including cardiac hemodynamic signals (including an intra-cardiac blood pressure signal, temperature signals, a blood flow speed signal), vital signs signals (including non-invasive (and invasive) blood pressure signals, respiration signals, SPO2 signal) and cardiac electrophysiological signals (including surface ECG signals, intra-cardiac electrograms, both unipolar and bipolar signals).

The input patient monitoring signals are acquired in step 636 and digitized and conditioned by patient monitoring system 39 and used by processor 33 for synchronization signal generation. In step 639 Synchronization processor 33 detects P wave, Q wave, R wave, T wave, S wave and U wave segments of a received signal data by detecting peaks within the received data using a known peak detector and by segmenting a signal represented by the received data into windows where the waves are expected and by identifying the peaks within the windows. The start point of a wave, for example, is identified by a variety of known different methods. In one method a wave start point comprises where the signal crosses a baseline of the signal (in a predetermined wave window, for example). Alternatively, a wave start point may comprise a peak or valley of signal. The baseline of the signal may comprise a zero voltage line if a static (DC) voltage signal component is filtered out from the signal. The signal processor includes a timing detector for determining time duration between the signal peaks and valleys. The time detector uses a clock counter for counting a clock between the peak and valley points and the counting is initiated and terminated in response to the detected peak and valley characteristics. In step 641 processor 33 provides generated synchronization signals to imaging system 25 for use in image acquisition.

In step 622 image data processor 21 and signal processor 15 process the derived displacement waveform data to determine the parameters of the Table of FIG. 5 and the pattern parameters and ratios previously described. Processor 21 and processor 15 perform statistical analysis including determination of mean, standard deviation, variability and variation of the determined parameters and also perform a hypothesis test for severity, type, timing in identifying pathology type. In addition the system determines and suggests a treatment in response to a statistical evaluation indicating treatment priority and waveform portion energy. In step 623 imaging data processor 21 selects a process to use for analysis of an acquired image to determine, a displacement waveform, time step used between image acquisitions, and to derive a 3D image reconstruction from 2D images, for example. Selectable processes include a process for point displacement waveform determination.

In step 625 image data processor 21 and signal processor 15 analyze the parameters and ratios derived from displacement waveform data in step 622 using predetermined mapping information in repository 17. The mapping information associates ranges of a value of an individual parameter of the individual parameters and ratios or values derived from the individual parameters and ratios, with corresponding medical conditions. Processor 15 compares the value of the individual parameters and ratios or values derived from the individual parameters and ratios, with the ranges and generates an alert message indicating a potential medical condition. Steps 622 and 625 are iteratively repeated in response to manual or automatic direction in step 628 to identify medical condition characteristics as additional images are iteratively acquired. In response to completion of iterative image analysis, signal processor 15 in step 631 determines location, size, volume, severity and type of medical condition as well as time within a heart cycle. Processor 15 initiates generation of an alert message for communication to a user in step 637 and provides medical information for use by a physician in making treatment decisions. Signal processor 15 in step 633 stores displacement waveform data and associated calculated parameters and ratios in repository 17.

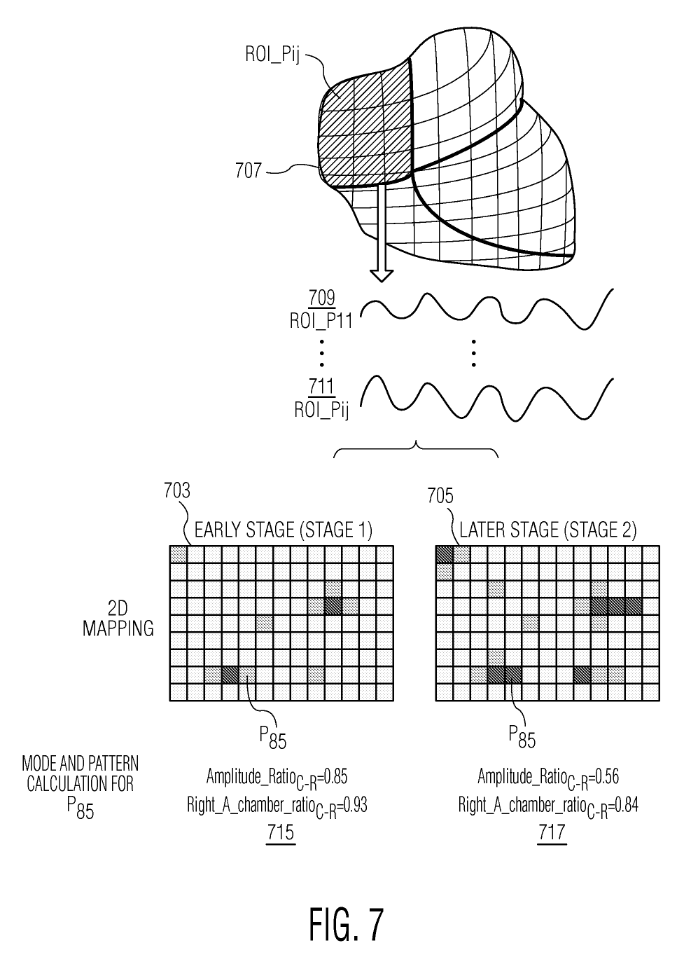

FIG. 7 shows atrial fibrillation (AF) and activity analysis based on heart activity waveform pattern analysis involving determination of single point amplitude contraction-reperfusion variation and chamber contraction-reperfusion ratio. There is a risk in over-burning and inaccurate ablation of tissue and electrical shock during ablation in Atrial chamber AF treatment. This risk is reduced by visual presentation of a grid of cell locations corresponding to cardiac tissue locations and indicating displacement waveform associated parameters and ratios. System 10 generates 2D mappings 703 and 705 for right atrial chamber early stage and late stage AF, respectively. Individual mapping grid cells of mappings 703 and 705 indicate displacement waveform associated ratios as previously described, for corresponding grid cells of atrial chamber area 707. A displacement waveform e.g. waveforms 709, 711 of a corresponding grid cell of atrial chamber 707 is detected by image data processor 21 by chamber surface edge movement detection.

The 2D mapping grid cell parameter and ratio values are determined from a sequence of individual images. A waveform of each chamber point is determined and extracted and pattern analysis ratios are selected (Amplitude_Ratio_{C-R} and Right_A_chamber_ratio_{C-R}) and calculated for each determined waveform for each grid cell for both early 715 and late stage 717 cases. The single point amplitude contraction-reperfusion variation (Amplitude_Ratio_{C-R}) and chamber contraction-reperfusion ratio (Right_A_chamber_ratio_{C-R}) are calculated for the right atrial chamber. Calculated area contraction-reperfusion ratios for cell P85 of mapping grids 703 and 705 are 0.85 and 0.56, respectively. Calculated chamber contraction-reperfusion ratios for cell P85 of mapping grids 703 and 705 are 0.93 and 0.84, respectively. It can be seen that in the early stage, the value of Amplitude_Ratio_{C-R} is 0.85, while in the later stage the values of the ratio is 0.56, which indicates significant change (exceeding a 20% change threshold). The Right_A_chamber_ratio_{C-R} for the two episodes is 0.93 and 0.84 respectively. Points of interest in a small area of the atrial chamber are monitored, by using the point displacement waveform cell analysis. The 2D mapping is used for function pathology diagnosis (such as severity, type, timing, latency), treatment method selection (such as ablation energy, timing, duration, ablation point priority) and prediction of a trend in cardiac function.

The calculated ratio comparison indicates the later AF stage shows more abnormal function cells and associated points indicating increase of atrial fibrillation points and an abnormal atrial area. The 2D maps 703, 705 facilitate determination of the severity of abnormal and potential AF points, and aids determination of the ablation priority and ablation energy for use in treatment and reduces AF treatment complexity and operation time. Multiple images are acquired and used to derive displacement waveforms of interesting points of a right atrial chamber. The extracted displacement waveforms of a ROI of the right atrial chamber are used to diagnose functionality and health status. A 5-cardiac-cycle window size and 200 mS time shift step is selected to calculate a mean and standard deviation of atrial chamber surface point displacement waveforms. Different ratios and parameters may be used for the atrial chamber abnormal function characterization.

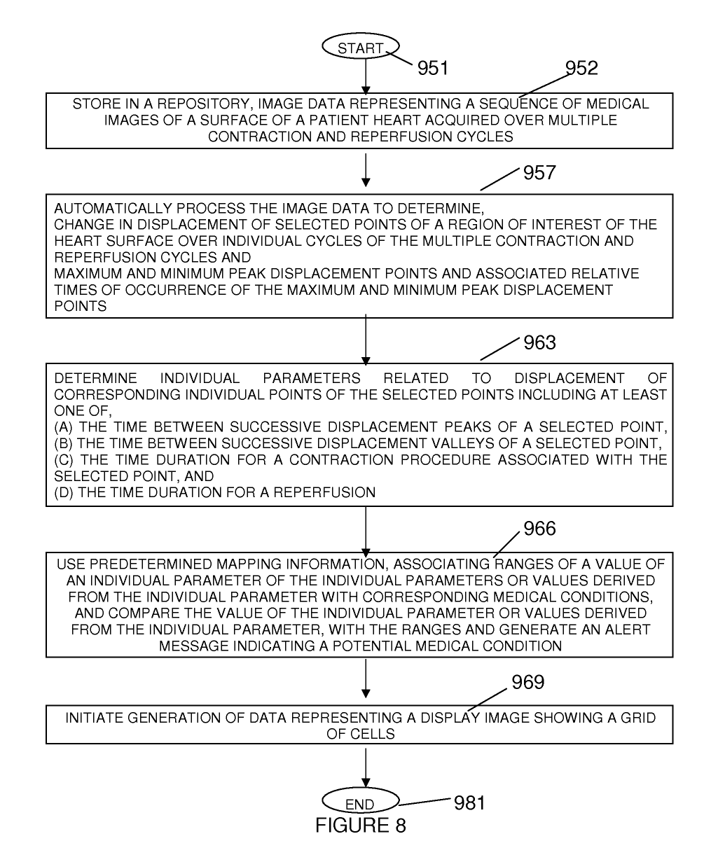

FIG. 8 shows a flowchart of a process used by system 10 for heart performance characterization and abnormality detection. In step 952 following the start at step 951, imaging system 25 stores in repository 17, image data representing a sequence of medical images of a surface of a patient heart acquired over multiple contraction and reperfusion cycles. In step 957 image data processor 21 automatically processes the image data to determine, change in displacement of selected points of a region of interest of the heart surface over individual cycles of the multiple contraction and reperfusion cycles and maximum and minimum peak displacement points and associated relative times of occurrence of the maximum and minimum peak displacement points. The change in displacement of selected points of a region of interest comprises substantially continuous waveforms comprising discrete data points of corresponding selected points.

Signal processor 15 in step 963 determines individual parameters related to displacement of corresponding individual points of the selected points including at least one of, (a) the time between successive displacement peaks of a selected point, (b) the time between successive displacement valleys of a selected point, (c) the time duration for a contraction procedure associated with the selected point, and (d) the time duration for a reperfusion. Processor 15 determines an individual parameter of the individual parameters comprising at least one of, (i) displacement amplitude of a displacement waveform associated with a contraction procedure, (ii) displacement amplitude of a displacement waveform associated with a reperfusion procedure and (iii) peak to peak maximum displacement amplitude of a displacement waveform. Further, the change in displacement of selected points of a region of interest comprises substantially continuous waveforms comprising discrete data points of corresponding selected points. An individual parameter of the individual parameters comprises A_{contraction}, displacement amplitude of a displacement waveform associated with the contraction procedure referenced to a zero DC value of the displacement waveform.

An individual parameter of the individual parameters comprises Tp, the time between successive displacement peaks of a selected point encompassing T_{contraction} the time duration for a contraction procedure associated with the selected point. An individual parameter of the individual parameters also comprises Tv, the time between successive displacement valleys of a selected point occurring prior to end of a contraction procedure, T_{contraction} the time duration for a contraction procedure associated with the selected point or T_{reperfusion}, the time duration for a reperfusion procedure associated with the selected point. An individual parameter of the individual parameters further comprises, A_{reperfusion}, displacement amplitude of a displacement waveform associated with the reperfusion procedure referenced to a zero DC value of the displacement waveform, Amax, a peak to peak maximum displacement amplitude of a displacement waveform or at least one of S_{contraction} and S_{reperfusion} associated with an area under a displacement peak. In one embodiment, an individual parameter of the individual parameters is derived using a mean or standard deviation of displacement of the selected points and indicates change of displacement of a selected point of the selected points over the multiple contraction and reperfusion cycles. Further, the individual parameters related to displacement of corresponding individual points of the selected points comprise displacement data.

In step 966 signal processor 15 uses predetermined mapping information, associating a threshold and ranges of a value of an individual parameter of the individual parameters or values derived from the individual parameter with corresponding medical conditions. Processor 15 compares the value of the individual parameter or values derived from the individual parameter, with the threshold and ranges and generates an alert message indicating a potential medical condition. The predetermined mapping information associates ranges of the value of the individual parameter or values derived from the individual parameter with particular patient demographic characteristics and with corresponding medical conditions and the image data processor uses patient demographic data including at least one of, age weight, gender and height in comparing the value of the individual parameter or values derived from the individual parameter with the ranges and generating an alert message indicating a potential medical condition.

In step 969 display processor 39 initiates generation of data representing a display image showing a grid of multiple cells individually representing the individual parameters and an individual cell employs a visual attribute to visually indicate degree of change in an associated individual parameter occurring over the multiple contraction and reperfusion cycles. The grid of the multiple cells is the shape of a heart and substantially indicates location of the selected points on the heart surface and the visual attribute comprises at least one of, (a) color, (b) shading, (c) text, (d) a symbol and (e) highlighting. In one embodiment, the display image shows first and second different grids of multiple cells individually representing individual parameters determined on first and second different occasions and enabling a user to visually compare differences in the individual parameters between the two occasions. The process of FIG. 8 terminates at step 981.

A processor as used herein is a computer, processing device, logic array or other device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example, and is conditioned using executable instructions to perform special purpose functions not performed by a general purpose computer. A processor may be coupled (electrically and/or as comprising executable components) with any other processor enabling interaction and/or communication there-between. A display processor or generator is a known element comprising electronic circuitry or software or a combination of both for generating display images or portions thereof.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-8 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system uses non-invasive continuous image scanning of chamber contraction and reperfusion to analyze blood flow and related hemodynamic functions by deriving tissue point displacement waveforms from acquired images and deriving parameters from the displacements waveforms. Further, the processes and applications may, in alternative embodiments, be located on one or more (e.g., distributed) processing devices on a network linking the units of FIG. 1. Any of the functions and steps provided in FIGS. 1-8 may be implemented in hardware, software or a combination of both.

What is claimed is:

1. A system for heart performance monitoring and abnormality detection, comprising:
a repository of image data representing a sequence of medical images of a surface of a patient heart acquired over a plurality of contraction and reperfusion cycles;
an image data processor for automatically processing said image data to determine,
change in displacement of selected points of a region of interest of the heart surface over individual cycles of said plurality of contraction and reperfusion cycles,
maximum and minimum peak displacement points and associated relative times of occurrence of said maximum and minimum peak displacement points and
individual parameters related to change in displacement of corresponding individual points of said selected points; and
a display processor for initiating generation of data representing a display image showing a grid of a plurality of cells individually representing said individual parameters and an individual cell employs a visual attribute to visually indicate degree of change in an associated individual parameter occurring over said plurality of contraction and reperfusion cycles.

2. A system according to claim 1, wherein
said change in displacement of selected points of a region of interest comprises a substantially continuous waveform comprising discrete data points and
said grid of said plurality of cells is the shape of a heart and substantially indicates location of said selected points on said heart surface

3. A system according to claim 2, wherein
said visual attribute comprises at least one of, (a) color, (b) shading, (c) text, (d) a symbol and (e) highlighting.

4. A system according to claim 1, wherein
said display image shows first and second different grids of a plurality of cells individually representing individual parameters determined on first and second different occasions and enabling a user to visually compare differences in the individual parameters between the two occasions.

5. A system according to claim 1, wherein
said individual parameters related to displacement of corresponding individual points of said selected points comprise displacement data.

6. A system according to claim 1, wherein
an individual parameter of said individual parameters comprises Tp, the time between successive displacement peaks of a selected point encompassing T_{contraction} the time duration for a contraction procedure associated with the selected point.

7. A system according to claim 1, wherein
an individual parameter of said individual parameters comprises Tv, the time between successive displacement valleys of a selected point occurring prior to end of a contraction procedure.

8. A system according to claim 1, wherein
an individual parameter of said individual parameters comprises T_{contraction} the time duration for a contraction procedure associated with the selected point.

9. A system according to claim 1, wherein
an individual parameter of said individual parameters comprises T_{reperfusion}, the time duration for a reperfusion procedure associated with the selected point.

10. A system according to claim 1, wherein
said change in displacement of selected points of a region of interest comprises substantially continuous waveforms comprising discrete data points of corresponding selected points and
an individual parameter of said individual parameters comprises A_{contraction}, displacement amplitude of a displacement waveform associated with the contraction procedure referenced to a zero DC value of the displacement waveform.

11. A system according to claim 1, wherein
said change in displacement of selected points of a region of interest comprises substantially continuous waveforms comprising discrete data points of corresponding selected points and an individual parameter of said individual parameters comprises A_{reperfusion}, displacement amplitude of a displacement waveform associated with the reperfusion procedure referenced to a zero DC value of the displacement waveform.

12. A system according to claim 1, wherein
said change in displacement of selected points of a region of interest comprises substantially continuous waveforms comprising discrete data points of corresponding selected points and
an individual parameter of said individual parameters comprises Amax, a peak to peak maximum displacement amplitude of a displacement waveform.

13. A system according to claim 1, wherein
said change in displacement of selected points of a region of interest comprises substantially continuous waveforms comprising discrete data points of corresponding selected points and
an individual parameter of said individual parameters comprises at least one of S_{contraction} and S_{reperfusion} associated with an area under a displacement peak.

14. A system according to claim 1, wherein
an individual parameter of said individual parameters is derived using a mean or standard deviation of displacement of said selected points.

15. A system according to claim 1, wherein
an individual parameter of said individual parameters indicates change in displacement of a selected point of said selected points over said plurality of contraction and reperfusion cycles.

16. A system according to claim 1, including
a signal processor uses predetermined mapping information, associating ranges of a value of an individual parameter of said individual parameters or values derived from said individual parameter with corresponding medical conditions, and compares said value of said individual parameter or values derived from said individual parameter, with said ranges and generates an alert message indicating a potential medical condition.

17. A system according to claim 16, wherein
said predetermined mapping information associates ranges of said value of said individual parameter or values derived from said individual parameter with particular patient demographic characteristics and with corresponding medical conditions and said data processor uses patient demographic data including at least one of, age weight, gender and height in comparing said value of said individual parameter or values derived from said individual parameter with said ranges and generating an alert message indicating a potential medical condition.

18. A system according to claim 1, including
a signal processor uses predetermined mapping information, associating a threshold value with a value of an individual parameter of said individual parameters or values derived from said individual parameter with corresponding medical conditions, and compares said distribution data or values derived from said distribution data, with said threshold value and generates an alert message indicating a potential medical condition.

19. A system for heart performance monitoring and abnormality detection, comprising:
a repository of image data representing a sequence of medical images of a surface of a patient heart acquired over a plurality of contraction and reperfusion cycles;
an image data processor for automatically processing said image data to determine,
change in displacement of selected points of a region of interest of the heart surface over individual cycles of said plurality of contraction and reperfusion cycles and
maximum and minimum peak displacement points and associated relative times of occurrence of said maximum and minimum peak displacement points; and
a signal processor for determining individual parameters related to displacement of corresponding individual points of said selected points including at least one of,
(a) the time between successive displacement peaks of a selected point, (b) the time between successive displacement valleys of a selected point,
(c) the time duration for a contraction procedure associated with the selected point, and
(d) the time duration for a reperfusion.

20. A system according to claim 19, wherein
said change in displacement of selected points of a region of interest comprises substantially continuous waveforms comprising discrete data points of corresponding selected points and said signal processor determines an individual parameter of said individual parameters comprising at least one of,
(i) displacement amplitude of a displacement waveform associated with a contraction procedure,
(ii) displacement amplitude of a displacement waveform associated with a reperfusion procedure and
(iii) peak to peak maximum displacement amplitude of a displacement waveform.

21. A system for method heart performance monitoring and abnormality detection, comprising the steps of:
storing in a repository, image data representing a sequence of medical images of a surface of a patient heart acquired over a plurality of contraction and reperfusion cycles;
automatically processing said image data to determine,
change in displacement of selected points of a region of interest of the heart surface over individual cycles of said plurality of contraction and reperfusion cycles,
maximum and minimum peak displacement points and associated relative times of occurrence of said maximum and minimum peak displacement points and
individual parameters related to change in displacement of corresponding individual points of said selected points; and
initiating generation of data representing a display image showing a grid of a plurality of cells individually representing said individual parameters and an individual cell employs a visual attribute to visually indicate degree of change in an associated individual parameter occurring over said plurality of contraction and reperfusion cycles.
